(19) United States
(12) Patent Application Publication
(10) Pub. No.: US 2020/0305569 A1
(43) Pub. Date: Oct. 1, 2020

(54) INFLATABLE HOUSING BLADDERS

(71) Applicant: Hewlett-Packard Development Company, L.P., Spring, TX (US)

(72) Inventor: David H. Hanes, Fort Collins, CO (US)

(73) Assignee: Hewlett-Packard Development Company, L.P., Spring, TX (US)

(21) Appl. No.: 16/650,075

(22) PCT Filed: Jan. 17, 2018
(86) PCT No.: PCT/US2018/014118

§ 371 Date: Mar. 24, 2020

(51) Int. Cl. A45C 13/02; H04B 1/3888; G06F 1/16

(52) U.S. Cl. CPC A45C 13/021; H04B 1/3888; A45C 2011/002; A45C 2013/025; G06F 1/1656

(57) ABSTRACT

Example implementations relate to inflatable housing bladders. For instance, in an example a system can include a bladder to be disposed in a cavity defined by a housing, a sensor, and an inflation mechanism coupled to the bladder to inflate the bladder responsive to a signal from the sensor.

### BACKGROUND

A user may transport electronic devices (smartphones, PC notebooks, tablets, fitness trackers, etc.) from a location to another location. For example, a user may place an electronic device in a backpack or other type of enclosure to transport an electronic device from a location to another location.

### BRIEF DESCRIPTION OF THE DRAWINGS

FIG. 1 illustrates a diagram of an example of a system including a bladder according to the disclosure.

FIG. 2 illustrates a diagram of an example of a system including an inflated bladder according to the disclosure.

FIG. 3 illustrates a view of an example of a storage apparatus including a bladder according to the disclosure.

FIG. 4 illustrates a diagram of an example of a controller according to the disclosure.

### DETAILED DESCRIPTION

As mentioned, a user may transport an electronic device (e.g., smartphones, PC notebooks, tablets, fitness trackers, etc.) in a backpack or other type of enclosure. However, the electronic device may shift or otherwise move within the enclosure due to the electronic device being a different size and/or shape than the enclosure. For instance, the electronic device in an enclosure may move within the enclosure during transport. Such movement may damage the electronic device.

As such, the present disclosure is directed to inflatable housing bladders. For example, an inflatable housing bladder system can include a bladder to be disposed in a cavity defined by a housing, a sensor; and an inflation mechanism coupled to the bladder to inflate the bladder responsive to a signal from the sensor, as described herein. Notably, such bladders can remain deflated and be selectively inflated to contact and ‘pin’ an electronic device in the cavity securely against a surface of the cavity and thereby prevent unwanted movement of the electronic device, For instance, in some examples an inflation mechanism such as a compressed gas canister can inflate a bladder in event of an emergency such as when a system/storage apparatus is accidently or intentionally “dropped”, as detailed herein.

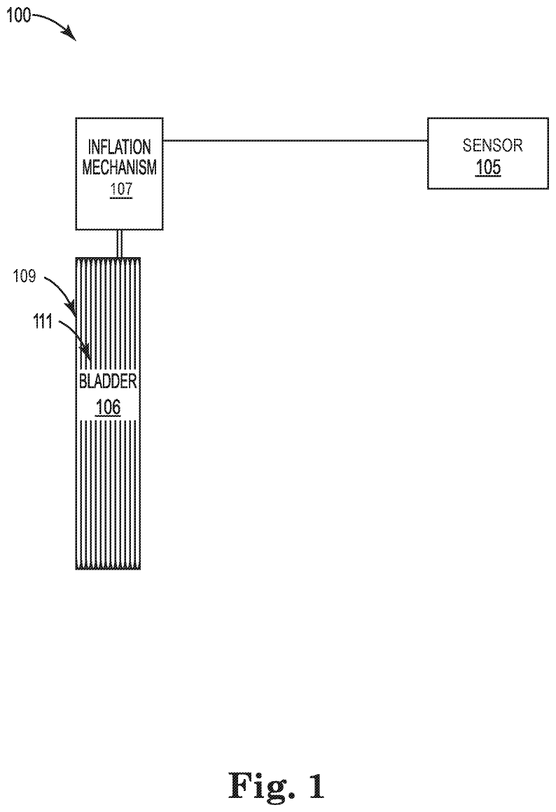

FIG. 1 illustrates a diagram of an example of a system 100 including a bladder 106 according to the disclosure. As illustrated in FIG. 1, the system 100 can include a sensor 105, a bladder 106, and an inflation mechanism 107 coupled to the bladder 106, among other possible components including those described herein.

The system 100 can be disposed in a storage apparatus or can be integral in a storage apparatus, As used herein, “disposed” means a location at which something is physically positioned. For instance, in some examples the system 100 can be separate and distinct from a storage apparatus and selectively disposed in or removed from a cavity of a storage apparatus. In this manner, the system 100 can be retrofit into a variety of storage apparatuses, However, in some examples, the system can be integral with a storage apparatus and have at least a portion of the system 100 intended to remain disposed in a cavity and/or other portion of a storage apparatus.

The sensor 105 can include an accelerometer, global positioning system, and/or a compass, among other types of sensors. That is, in some examples the sensor 105 can include an accelerometer. An accelerometer refers to an electromechanical device that can measure proper acceleration or rate of change of velocity of a body in its own instantaneous rest frame. That is, as used herein acceleration refers to a measurement of a change in velocity of an object divided by time. The accelerometer may detect a magnitude and/or direction of proper acceleration as a vector quantity that may be utilized to detect an orientation. Acceleration can be due to the application of acceleration forces to an object. Acceleration forces may be static such as a continuous force of gravity or dynamic to sense movement and/or vibrations. In some examples, the system 100 can include a plurality of accelerometers such as a total of three accelerometers to together detect acceleration, among other possibilities. The accelerometer can be an individual or a multiple axis accelerometer. In some examples, the accelerometer can be a micromachined micro electrical system (MEMS) accelerometer, among other possibilities.

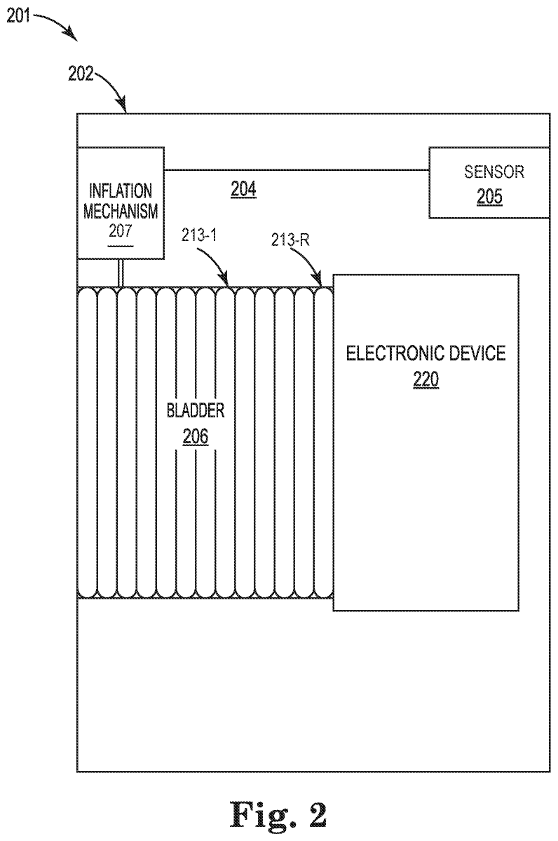

The bladder 106 refers to a device having a chamber (i.e., a hollow portion) that can be inflated. For instance, as illustrated in FIG. 1 the bladder can include a wall 100 and a chamber 111 formed and defined by the wall 109. The bladder 106 can be formed of a plastic, a rubber, vinyl, and/or various elastomers, among other possibilities. The bladder can be U-shaped, square, spherical, and/or rectangular, among other possible shapes. In some examples, the bladder 106 can be formed of a plurality of pockets that together form the chamber 111. For instance, the chamber can be formed of a plurality of ribbed compartments that are coupled together, as detailed herein with respect to FIG. 2. FIG. 1 illustrates the bladder 106 as being deflated. However, the bladder 106 can be inflated as detailed herein by the inflation mechanism 107.

The inflation mechanism 107 (and similarly the first inflation mechanism and second inflation mechanism described herein) refers to a device that via suction or pressure can force gas such as air into a bladder such as the bladder 106. A total number of inflation mechanisms can be varied, For instance, in some examples the system 100 can include a total of one, two, or three inflation mechanisms, among other possibilities. Examples of an inflation mechanism include an electric pump, a non-electric pump, and a compressed gas canister, among other possibilities.

As used herein an electric pump refers to an electromechanical device that via suction or pressure can force gas such as air into a bladder such as the bladder 106. Examples of electric pumps include electrical rotary positive displacement pumps, electrical rotary vane pump, electrical reciprocating positive displacement pumps, among other types of electrical pumps.

As used herein a non-electric pump refers to a mechanical device that via suction or pressure can force gas such as air into a bladder such as the bladder 106. Examples of non-electric pumps include hand pumps such as those that employ a tube/syringe and/or a compressible bulb, among other types of non-electric pumps.

As used herein a compressed gas canister refers to a container including a gas at a pressure that is greater than ambient pressure (an absolute pressure of ˜101325 pascals). Examples of compressed gas include air and nitrogen, among other possibilities. The compressed gas canister can selectively release the compressed gas. For instance, the compressed gas canister can be punctured or can be coupled to a valve that is opened to release gas, among other possibilities.

A compressed gas canister can be sized (e.g., include a given volume of gas) to inflate a bladder a predetermined amount. For instance, a volume of the compressed gas when decompressed (to ambient pressure or other pressure of the bladder) can be equal to a volume of the bladder. However, in some examples a volume of the compressed gas when decompressed can be greater than a volume of the bladder (e.g., to permit multiple instances of the compressed gas canister filling the volume of the bladder).

FIG. 2 illustrates a diagram of an example of a system 201 including an inflated bladder according to the disclosure. As illustrated in FIG. 2, the system 201, can include a housing 202 defining a cavity 204, a sensor 205, a bladder 206, an inflation mechanism 207, and an electronic device 220. As illustrated in FIG. 2, the bladder 206 is inflated by the inflation mechanism 207 to disposition the electronic device 220 against the housing 202 and thereby prevent movement/damage to the electronic device when the bladder 206 is inflated.

The housing 202 can be formed of fabric, metal, and/or plastic, among other suitable material to promote inflatable housing bladders. The housing 202 can be disposed in a storage apparatus and/or form at least a portion of a storage apparatus. Examples of storage apparatuses include a backpack, a suitcase, a messenger bag, and/or combinations thereof, among other possible types of storage apparatuses suitable to store the electronic device 220 in the cavity 204. The cavity 204 refers to at least a portion of an internal volume defined by the housing 202. That is, the cavity can have a volume equal to some or all of the volume defined by the housing 202. A total number of cavities in the housing 202 can be varied. The cavity 204 can be sized to receive the electronic device 220. For instance, the cavity 204 can have a dimension/volume equal to or greater than the dimensions/volume of the electronic device 220.

The electronic device 220 can be a mobile phone, a wearable electronic device, a tablet, a laptop computer, a desktop computer, or combinations thereof, among other types of electronic devices. In some examples, the electronic device 220 can be an all-in-one (AIO) computer. As used herein, an AIO computer refers to a computer which integrates the internal components into the same case as the display, and offers the touch input functionality of the tablet devices while also providing the processing power and viewing area of desktop computing systems.

For instance, in various examples the system 201 can include the bladder 206 to be disposed in the cavity 204 defined by a housing 202 and the inflation mechanism 207 coupled to the bladder 206 (in fluid communication with the bladder) can inflate the bladder 206 responsive to a signal from the sensor 205. For example, the inflation mechanism 207 can be a compressed gas container to inflate the bladder 206 responsive to a signal from an accelerometer or other component/sensor. For instance, the sensor 205 can include an accelerometer to measure an acceleration of the housing 202 or other component included in the system 201 and send a signal to inflate the bladder 206 when a measured acceleration meets (e.g., 6.0 meters/second²) and/or exceeds an acceleration threshold (3.0 meters/second²) to protect the electronic device disposed in the cavity 204.

As mentioned, the bladder 206 can include or otherwise be formed of ribbed compartments 213-1, . . . , 213-R that are coupled together. A total number of the ribbed compartments can be varied. In some examples, each of the ribbed compartments is substantially equal in volume (within +/−5 percent of a volume) to promote uniform inflation and/or deflation of the bladder 206 as a whole. A shape and/or size and/or other aspects of the bladder 206 can be varied. For instance, while illustrated in FIG. 2 as being formed of a plurality of ribbed compartments in some examples the bladder 206 can be formed of a unitary body and is not formed of ribbed compartments.

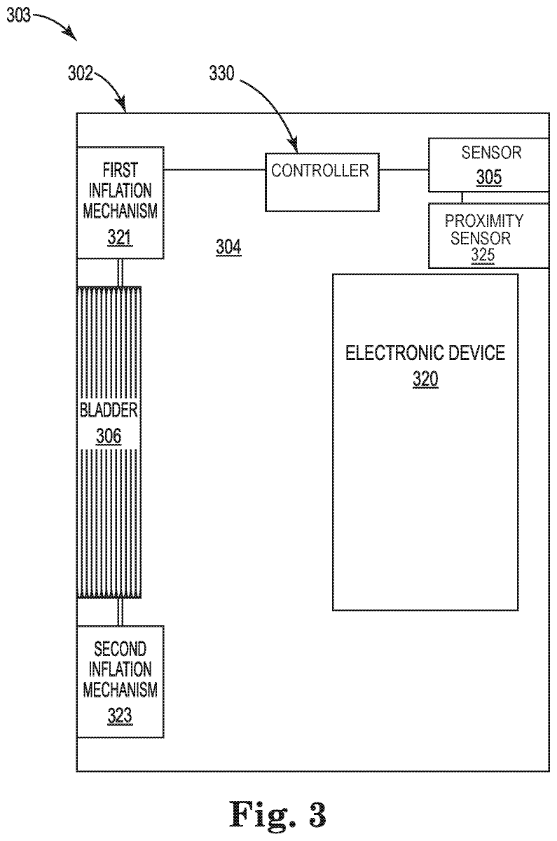

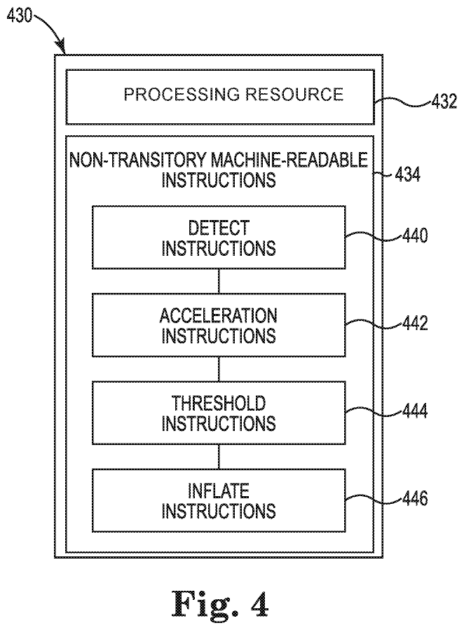

FIG. 3 illustrates a view of an example of a storage apparatus 303 including a bladder according to the disclosure. As illustrated in FIG. 3, the storage apparatus 303 can include a housing 302 defining a cavity 304, a sensor 305, a bladder 306, an electronic device 320, a first inflation mechanism 321, a second inflation mechanism 323, and a controller 330. As detailed herein with respect to FIG. 4, the controller 330 can include a processing resource and a non-transitory computer readable medium including instructions executable by the processing resource to perform various items related to inflatable housing bladders.

In some examples, the first inflation mechanism 321 can be a non-electrically powered device and/or an electrically powered device. In some examples, the second inflation mechanism 323 can be a compressed gas container. For instance, in some examples, the first inflation mechanism 321 can be a non-electrically powered device and/or an electrically powered device while the second inflation mechanism 323 can be a compressed gas container. In such examples, the first inflation mechanism 321 is to inflate the bladder 306 in various circumstances such as responsive to a user input while the second inflation mechanism is to inflate the bladder 306 in other circumstances such as responsive to a signal from the sensor 305. For instance, the controller can cause the second inflation mechanism to 323 inflate the bladder 306 responsive to a signal from the sensor 305. That is, the controller and/or the sensor can assert, maintain, and/or de-assert a signal to cause the second inflation mechanism to inflate the bladder 306. That is, in some examples the controller 330 is to cause compressed gas from the second inflation mechanisms (e.g. a compressed gas container) to inflate the bladder 306 responsive to a signal from the sensor. Similarly, the controller 330 can assert, maintain, or de-assert a signal to cause the first inflation mechanism 321 to inflate the bladder 306.

In some examples, the second inflation mechanism 323 can be removably coupled to the housing 302 or other component in the storage apparatus 303. As used herein, removably couple refers to a mechanical coupling via an attachment mechanism of two distinct components such as a second inflation mechanism and the housing 302 that are intended to be selectively decoupled. Examples of attachment mechanisms include snap or press fit mechanism, mechanical clips, friction fit components, mechanical fasteners such as screws, bolts, etc. and/or a mounting ear and corresponding flange, among other types of suitable attachment mechanisms to removably couple components together. In this manner, the second inflation mechanism 323 can readily be coupled and decoupled from the housing 302. For instance, following inflation of the bladder 306 the second inflation mechanism 323 can be removed and replaced with a new second inflation mechanism that is full of compressed gas. However, it is noted that in some examples the second inflation mechanism 323 can be recharged (refilled with compressed gas) following inflation of the bladder 306 by the second inflation mechanism 323. In some examples, the first inflation mechanism 321 can be non-removably coupled to the housing 302 or other component of the storage apparatus 303, among other possibilities.

While FIG. 3 illustrates the storage apparatus 303 as including a total of two inflation mechanisms the storage apparatus 303 and/or a system such as those described herein can include more or fewer inflation mechanisms. For instance, in some examples the storage apparatus 303 can include each of an electric pump, a non-electric pump, and a compressed gas canister to permit inflation of the bladder 306 via electric pump, a non-electric pump, and a compressed gas canister, and/or combinations thereof.

In some examples the storage apparatus 303 (or a system to be included in the storage apparatus) can include a microphone. The controller 330 can cause the bladder to inflate or deflate responsive to a voice command received via the microphone. The voice command can be a predetermined word, phrase, and/or sound, among other possibilities. That is, in some examples the controller 330 can cause the first inflation mechanism 321 and/or the second inflation mechanism 323 to inflate the bladder responsive to a voice command. For instance, a user may place the storage apparatus 303 on their back/shoulder and then provide a voice command to inflate the bladder 306. Similarly, a user may remove the storage apparatus 303 from their back/shoulder and then provide a voice command to deflate the bladder 306. For instance, the first inflation mechanism 321 can deflate the bladder 306 and/or the bladder 306 can be coupled to a release valve that can be actuated by a user or otherwise to deflate the bladder 306.

In some examples, the storage apparatus 303 (or a system to be included in the storage apparatus) can include a proximity sensor 325, as illustrated in FIG. 3 to sense whether an electronic device is present in the cavity. The proximity sensor 325 can be a time-of-flight (TOF) sensor, among other types of proximity sensors. A TOF sensor can resolve distance based on a known speed of data (e.g., speed of light, etc.). For example, the TOF sensor can include an infra-red (IR) sensor and an IR emitter. The IR emitter can emit data outward, the data can bounce off of an object (e.g., an electronic device), and the data that is bounced back can be received by the IR sensor. The time-of-flight sensor can determine a time from when the data left to when the data is received back. The determined time can indicate a location and/or presence of an object such as an electronic device. The proximity sensor 325 can determine whether an electronic device is present in the cavity 304 periodically, responsive to an event such as a housing or other component of a storage apparatus moving (e.g., open/closing of the housing 302), responsive to movement of the storage apparatus 303 (e.g., based on a change in location or other movement as detected by a global positioning system/gyroscope or other equipment included in the storage apparatus), and/or responsive to a user input/contact with the storage apparatus 303.

In some examples, the controller 330 is to place an inflation mechanism (e.g., a second inflation mechanism and/or a compressed gas canister) in a drop protect mode. As used herein, drop protect mode refers to activating an inflation mechanism so the inflation mechanism can inflate the bladder 306. Examples of activation include opening a valve or otherwise permitting a fluid coupling or potential fluidic coupling between the inflation mechanism in drop protect mode and the bladder 306. For instance, the controller 330 can place an inflation mechanism in drop protect mode responsive to when an electronic device is present in the cavity 304 (e.g., as determined by the proximity sensor 325).

In some examples, the controller 330 is to place an inflation mechanism (e.g., a second inflation mechanism and/or a compressed gas canister) in a standby mode. As used herein, standby mode refers to inactivating an inflation mechanism such that the inflation mechanism cannot inflate the bladder 306. Examples of inactivation include closing a valve or otherwise removing a fluid coupling or potential fluidic coupling between the inflation mechanism in standby mode and the bladder 306. For instance, the controller 330 can place an inflation mechanism in standby mode responsive to when an electronic device is absent from the cavity 304 (e.g., as determined by the proximity sensor 325).

FIG. 4 illustrates a diagram of an example of a controller according to the disclosure. As illustrated in FIG. 4, the controller 430 can include a processing resource 432 and a non-transitory computer readable medium 434.

The processing resource 432 can be a central processing unit (CPU), a semiconductor based micro-processing resource, and/or other hardware devices suitable for retrieval and execution of computer-readable instructions such as those stored on the non-transitory computer readable medium 434.

The non-transitory computer readable medium 434 may be any electronic, magnetic, optical, or other physical storage device that stores executable instructions. Thus, non-transitory computer readable medium 434 may be, for example, Random Access Memory (RAM), an Electrically-Erasable Programmable Read-Only Memory (EEPROM), a storage drive, an optical disc, and the like.

The executable instructions may be “installed” on the controller 430 illustrated in FIG. 3. Non-transitory computer readable medium 434 may be a portable, external, or remote storage medium, for example, that allows the controller 430 to download the instructions from the portable/external/remote storage medium. In this situation, the executable instructions may be part of an “installation package”. As described herein, non-transitory computer readable medium 434 may be encoded with executable instructions related to inflatable housing bladders.

For instance, in various examples, processing resource 432 can execute detect instructions 440 to detect a presence of an electronic device in a cavity defined by a housing. Detection can include receiving infrared light or other light/signal indicative of the presence of an object in a field of view of a motion detector or other type of proximity sensor such as a time of flight proximity sensor, a near field communication sensor etc.

In various examples, processing resource 432 can execute acceleration instructions 442 to measure a rate of acceleration of the housing. For example, the acceleration instructions 442 can measure a rate of acceleration of the housing responsive to the electronic device being detected, by detect instructions 440, in the housing, among other possibilities.

In various examples, processing resource 432 can execute threshold instructions 444 to compare the measured rate of acceleration, as measured by the acceleration instructions 442, to an acceleration threshold, as described herein. An acceleration threshold can be equal to a predetermined amount of acceleration (e.g., 8.0 meters/second², 7.0 meters/second², 6.0 meters/second², 5.0 meters/second², 4.0 meters/second², 3.0 meters/second², 2.0 meters/second², and/or can be specified by a user, among other possibilities.

In some examples, the measured rate of acceleration can meet or exceed the acceleration threshold for a predetermined duration prior to sending a signal to inflate a bladder to avoid inadvertently inflating the bladder. For instance, a duration can be 1 second, 2 seconds, and/or 3 seconds, and/or can be specified by a user, among other possibilities.

In various examples, processing resource 432 can execute inflate instructions 446 to cause a bladder in the cavity to inflate when the measured rate of acceleration exceeds the acceleration threshold (as determined by the acceleration instructions 442), among other possibilities. For instance, as mentioned the inflate instructions 446 can include instructions to inflate the bladder when the measured rate of acceleration exceeds the acceleration threshold for a predetermined duration (e.g., 2 seconds).

In some examples, the detect instructions 440 can include instructions to detect an absence of the electronic device in the cavity. As mentioned, detection can include receiving infrared light or other light indicative of the presence, or absence, of an object (electronic device) in a field of view of a motion detector or other type of proximity sensor such as a time of flight proximity sensor, etc. In such examples, the instructions can further include instructions to cause the bladder in the cavity to remain deflated when the measured rate of acceleration exceeds the acceleration threshold (and if specified exceeds a predetermined duration) when the electronic device is absent from the cavity to avoid inadvertently inflating the bladder when the electronic device is absent (not present in) the cavity.

In the foregoing detailed description of the disclosure, reference is made to the accompanying drawings that form a part hereof, and in which is shown by way of illustration how examples of the disclosure may be practiced. The figures herein follow a numbering convention in which the first digit corresponds to the drawing figure number and the remaining digits identify an element or component in the drawing. For example, reference numeral 106 may refer to element 106 in FIG. 1 and an analogous element may be identified by reference numeral 206 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

What is claimed:

1. A system comprising:
a bladder to be disposed in a cavity defined by a housing;
a sensor; and
an inflation mechanism coupled to the bladder to inflate the bladder responsive to a signal from the sensor.

2. The system of claim 1, wherein the bladder includes ribbed compartments that are coupled together, wherein each of the ribbed compartments is substantially equal in volume.

3. The system of claim 2, wherein the inflation mechanism is comprised of a compressed gas container.

4. The system of claim 3, wherein the sensor further comprises an accelerometer, wherein the system further comprises a controller to cause compressed gas from the compressed gas container to inflate the bladder responsive to the signal from the accelerometer.

5. The system of claim 4, further comprising a proximity sensor to sense whether an electronic device is present in the cavity.

6. The system of claim 5, wherein the controller is to:
place the inflation mechanism in a drop protect mode responsive to the electronic device being present in the cavity; or
place the inflation mechanism in a standby mode responsive to the electronic device being absent from the cavity.

7. A storage apparatus comprising:
a housing defining a cavity to house an electronic device;
a bladder coupled to a surface of the cavity;
an accelerometer to detect acceleration of the housing;
a first inflation mechanism coupled to the bladder to inflate or deflate the bladder;
a second inflation mechanism coupled to the bladder to inflate the bladder; and
a controller to cause the second inflation mechanism to inflate the bladder responsive to a signal from the accelerometer.

8. The storage apparatus of claim 7, wherein the apparatus further comprises a backpack, a suitcase, a messenger bag, or combinations thereof.

9. The storage apparatus of claim 7, wherein the first inflation mechanism is comprised of a non-electrically powered device or an electrically powered device, and wherein the second inflation mechanism is comprised of a compressed gas container.

10. The storage apparatus of claim 7, wherein the second inflation mechanism is removably coupled to the housing.

11. The storage apparatus of claim 7, wherein the first inflation mechanism is non-removably coupled to the housing.

12. The storage apparatus of claim 7, where the first inflation mechanism comprises an electric pump, a non-electric pump, or a combination thereof, and wherein the second inflation mechanism comprises a compressed gas canister.

13. The storage apparatus of claim 7, wherein the device further comprises a microphone, and wherein the controller is to cause the bladder to inflate or deflate responsive to a voice command received via the microphone.

14. A non-transitory computer readable medium storing instructions executable by a processing resource to:
detect a presence of an electronic device in a cavity defined by a housing;
responsive to the electronic device being detected, measure a rate of acceleration of the housing;
compare the measured rate of acceleration to an acceleration threshold; and
cause a bladder in the cavity to inflate when the measured rate of acceleration exceeds the acceleration threshold.

15. The medium of claim 14, further comprising instructions to:
detect an absence of the electronic device in the cavity; and
cause the bladder in the cavity to remain deflated when the measured rate of acceleration exceeds the acceleration threshold and the electronic device is absent from the cavity.
